(19) United States
(12) Patent Application Publication
(10) Pub. No.: US 2026/0017090 A1
(43) Pub. Date: Jan. 15, 2026

(54) DATA PROCESSING METHOD AND APPARATUS, DEVICE, AND STORAGE MEDIUM

(71) Applicant: Lemon Inc., Grand Cayman (KY)

(72) Inventors: Lelin Zhang, Los Angeles, CA (US); Xiaoqi Li, Beijing (CN); Celong Liu, Los Angeles, CA (US); Shuai Wang, Beijing (CN); Pan Huang, Beijing (CN); Xin HUANG, Beijing (CN); Zeng Dai, Los Angeles, CA (US); Xing Mei, Los Angeles, CA (US)

(21) Appl. No.: 18/866,266

(22) PCT Filed: May 5, 2023
(86) PCT No.: PCT/SG2023/050306

§ 371 Date: Nov. 15, 2024

(30) Foreign Application Priority Data
May 16, 2022 (CN) 202210530042.0

(51) Int. Cl. G06F 9/48; G06F 9/50

(52) U.S. Cl. CPC G06F 9/4843; G06F 9/5038

(57) ABSTRACT

Embodiments of the present disclosure disclose a data processing method and apparatus, a device, and a storage medium. The method includes: obtaining an algorithm directed graph corresponding to a target task, where the algorithm directed graph includes a plurality of algorithm nodes, and one algorithm node corresponds to one processing algorithm; re-editing a processing algorithm that meets a set condition, to obtain a rewritten processing algorithm; and invoking a first processor to execute a processing algorithm that is not re-edited, and invoking a second processor to execute the rewritten processing algorithm, according to an execution sequence of the algorithm directed graph.

The present disclosure claims priority to Chinese Patent Application No. 202210530042.0, filed with the China National Intellectual Property Administration on May 16, 2022, which is incorporated herein by reference in its entirety.

### FIELD

Embodiments of the present disclosure relate to the field of computer technologies, and for example, to a data processing method and apparatus, a device, and a storage medium.

### BACKGROUND

To implement an image processing task, a plurality of algorithms generally need to be invoked. There are multiple switchings between a central processing unit (CPU) and a graphics processing unit (GPU) during running of these algorithms. However, switching between the CPU and the GPU requires data copying. According to the solutions in the related art, data needs to be copied multiple times, which results in large computing and memory overheads, affecting the processing efficiency of the entire task to some extent.

### SUMMARY

Embodiments of the present disclosure provide a data processing method and apparatus, a device, and a storage medium, which can reduce the number of switchings between a CPU and a GPU, thereby saving computing and memory resources and improving the data processing efficiency.

In a first aspect, an embodiment of the present disclosure provides a data processing method, including:
obtaining an algorithm directed graph corresponding to a target task, where the algorithm directed graph includes a plurality of algorithm nodes, and one algorithm node corresponds to one processing algorithm;
re-editing a processing algorithm that meets a set condition, to obtain a rewritten processing algorithm; and
invoking a first processor to execute a processing algorithm that is not re-edited, and invoking a second processor to execute the rewritten processing algorithm, according to an execution sequence of the algorithm directed graph.

In a second aspect, an embodiment of the present disclosure further provide a data processing apparatus, including:
an algorithm directed graph obtaining module configured to obtain an algorithm directed graph corresponding to a target task, where the algorithm directed graph includes a plurality of algorithm nodes, and one algorithm node corresponds to one processing algorithm;
a processing algorithm editing module configured to re-edit a processing algorithm that meets a set condition, to obtain a rewritten processing algorithm; and
a processor invoking module configured to invoke a first processor to execute a processing algorithm that is not re-edited, and invoke a second processor to execute the rewritten processing algorithm, according to an execution sequence of the algorithm directed graph.

In a third aspect, an embodiment of the present disclosure further provides an electronic device, including:
one or more processing apparatuses; and
a storage apparatus configured to store one or more programs, where
the one or more programs, when executed by the one or more processing apparatuses, cause the one or more processing apparatuses to implement the data processing method as described in the embodiment of the present disclosure.

In a fourth aspect, an embodiment of the present disclosure further provide a computer-readable medium having a computer program stored thereon, where the computer program, when executed by a processing apparatus, causes the data processing method as described in the embodiment of the present disclosure to be implemented.

### BRIEF DESCRIPTION OF THE DRAWINGS

FIG. 1 is a flowchart of a data processing method according to an embodiment of the present disclosure;

FIG. 2 is a diagram of an example of an algorithm directed graph according to an embodiment of the present disclosure;

FIG. 3 is a diagram of an example of an algorithm directed graph according to an embodiment of the present disclosure;

FIG. 4 is a diagram of an example of a processing process of an instance of a target task according to an embodiment of the present disclosure;

FIG. 5 is a schematic diagram of a structure of a data processing apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure are described below with reference to the accompanying drawings. Although some embodiments of the present disclosure are shown in the accompanying drawings, it should be understood that the present disclosure may be implemented in various forms. It should be understood that the drawings and the embodiments of the present disclosure are for exemplary purposes only.

It should be understood that the various steps described in the method implementations of the present disclosure may be performed in different orders, and/or performed in parallel. Furthermore, additional steps may be included and/or the execution of the illustrated steps may be omitted in the method implementations.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Intelligent creation: specifically an image and video content generation method based on computer vision and graphics that is used in video social platforms, in which the application of artificial intelligence (such as conventional machine learning or deep learning) and virtual reality/augmented reality technologies enables video content provided by users to be more diverse and richer.

Algorithm platform: a software system supporting scheduling and execution of algorithms that is used during intelligent creation by a user using a mobile platform or another personal computer (PC) platform. An input of the system is picture or video information from a camera and algorithms that need to be run. An execution sequence of and a dependency relationship between these algorithms are described and connected by means of a directed graph. An output of the system is running results of the algorithms, including image classification information, a target object detection bounding box and confidence, object segmentation information, a generated image, human body or object landmark information, etc.

The objective of the present solution is to enable an algorithm belonging to a set category in the algorithm directed graph to be executed by a set processor (such as a GPU), so that data can be completely (or mostly) executed on the set processor during transmission of the data in the algorithm directed graph, reducing the number of times for which data is copied between different processors, and thus achieving the effect of saving computing and memory resources. In this embodiment, in intelligent creation, each algorithm node in the algorithm directed graph is functionally expanded to the GPU while supporting a CPU function, so that the algorithm belonging to the set category can run on the GPU.

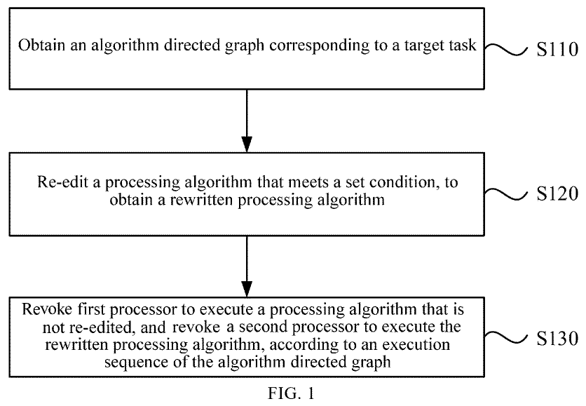

FIG. 1 is a flowchart of a data processing method according to an embodiment of the present disclosure. This embodiment is applicable to a case of invoking a processor to process data. The method may be performed by a data processing apparatus. The apparatus may be composed of hardware and/or software, and may generally be integrated in a device having a data processing function. The device may be an electronic device such as a server, a mobile terminal, or a server cluster. As shown in FIG. 1, the method may include the following steps.

At S110, an algorithm directed graph corresponding to a target task is obtained.

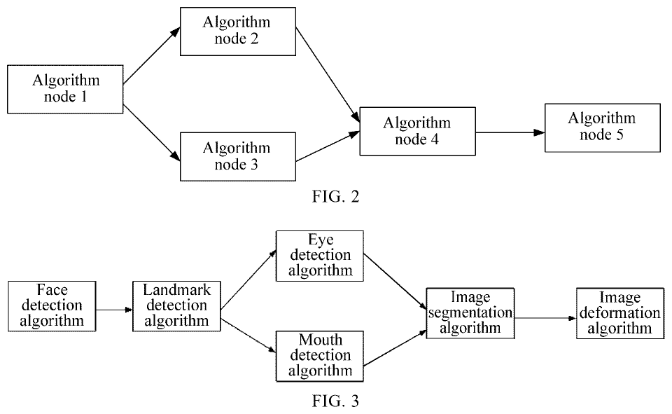

The algorithm directed graph includes a plurality of algorithm nodes, and one algorithm node corresponds to one processing algorithm. The plurality of algorithm nodes are connected to each other via directed edges. There is a dependency relationship between algorithm nodes at two ends of a directed edge. The algorithm node at a terminating end of the directed edge depends on the algorithm node at a starting end thereof. As an example, FIG. 2 is a diagram of an example of an algorithm directed graph in this embodiment. As shown in FIG. 2, the algorithm directed graph includes five algorithm nodes, in which both an algorithm node 2 and an algorithm node 3 depend on an algorithm node 1, an algorithm node 4 depends on the algorithm node 2 and the algorithm node 3, and an algorithm node 5 depends on the algorithm node 4.

The target task may be a data processing task for which a plurality of algorithms need to be invoked, and which may be an image processing task, an audio processing task, etc. In this embodiment, a solution to the image processing task is mainly discussed.

As an example, the algorithm directed graph corresponding to the target task may be obtained by: obtaining a plurality of processing algorithms required for the target task; determining a dependency relationship between the plurality of processing algorithms; and establishing the algorithm directed graph based on the dependency relationship.

The process of obtaining a plurality of processing algorithms required for the target task may include: first determining an initial state and a target state of an image or audio to be processed by the target task, then dividing the target task into a plurality of stages based on the initial state and the target state, and then determining a processing algorithm that needs to be invoked for each stage.

The dependency relationship between the plurality of processing algorithms may be determined by: first determining an execution sequence of the plurality of processing algorithms required for the target task, and then determining the dependency relationship between the processing algorithms according to the execution sequence.

The algorithm directed graph may be established based on the dependency relationship by: adding directed edges between algorithm nodes corresponding to the processing algorithms. A depended algorithm node is provided at the starting end of the directed edge, and a depending algorithm node is provided at the terminating end of the directed edge. As an example, a target task is to perform effect processing on an image, which goes through the stages of: first detecting a human face in the image, then detecting landmarks in the face, then determining eye positions and a mouth position based on the landmarks, then extracting the eyes and mouth, and finally deforming the eyes and mouth. As can be seen from the above, the algorithms that need to be invoked for the target task include a face detection algorithm, a landmark detection algorithm, an eye detection algorithm, a mouth detection algorithm, an image segmentation algorithm, and an image deformation algorithm. In addition, the dependency relationship between the algorithms is as follows: the landmark detection algorithm depends on a processing result of the face detection algorithm, the eye detection algorithm and the mouth detection algorithm depend on a processing result of the landmark detection algorithm, the image segmentation algorithm depends on processing results of the eye detection algorithm and the mouth detection algorithm, and the image deformation algorithm depends on a processing result of the image segmentation algorithm. The algorithm directed graph thus determined is shown in FIG. 3. In the technical solution of this embodiment, the algorithm directed graph is established based on the dependency relationship between the processing algorithms, so that the accuracy of the algorithm directed graph can be improved.

At S120, a processing algorithm that meets a set condition is re-edited, to obtain a rewritten processing algorithm.

The set condition may be that the processing algorithm belongs to a set category. The set category may be landmark detection, image segmentation (segmentation), and image transformation (such as a generative adversarial network (GAN)). The processing algorithm belonging to the set category has a feature that output data can be characterized in the form of an image (i.e., a renderable texture). For example, the GAN category may output data of a red, green, blue (RGB) type or of a red, green, blue, alpha (RGBA) type, the segmentation category may output a multi-dimensional normalized grayscale image (i.e., mask), and the landmark detection category may output a multi-dimensional normalized grayscale image for each landmark.

In this embodiment, the process of re-editing a processing algorithm that meets the set condition, to obtain a rewritten processing algorithm may include: re-editing the processing algorithm that meets the set condition according to a format supported by the second processor, and rewriting an input interface and an output interface of the processing algorithm into interfaces supported by the second processor, to obtain the rewritten processing algorithm.

The second processor may be a GPU. As an example, the source code of the processing algorithm that meets the set condition is first obtained, and is read line by line, algorithm parameters in the source code are extracted, and finally the extracted algorithm parameters are re-edited according to the format supported by the GPU. The interfaces supported by the second processor may be texture interfaces. As an example, Table 1 is a rewritten interface format:

TABLE 1

| | Texture | | |
|---|---|---|---|
| | identifier | Data size/ | |
| Type | (ID) | data sequence | Data format |
| Input | int | NHWC | u8, int8, int16, uint16, |
| Output | int | NHWC | float, fp16, double; |
| | | | Supported image channel |
| | | | types: RGB, RGBA, R |

As can be seen from Table 1, the data types supported by the rewritten interface may be RGB, RGBA or R. The data size may be expressed as NHWC, where N represents the parallelism of the GPU, H represents the height of the image, W represents the width of the image, and C represents the number of channels of the image. In this embodiment, the processing algorithm that meets the set condition is rewritten into the format supported by the GPU, so that the processing algorithm is executed by the GPU, and the data can be completely (or mostly) executed on the GPU during the transmission of the algorithm directed graph, reducing the number of times for which data is copied between the CPU and GPU.

At S130, a first processor is invoked to execute a processing algorithm that is not re-edited, and a second processor is invoked to execute the rewritten processing algorithm, according to an execution sequence of the algorithm directed graph.

For example, the first processor may be the CPU, and the second processor may be the GPU. The writing format of a processing algorithm that does not meet the set condition cannot be rewritten, and the CPU still needs to be invoked for execution. For example, for image classification and object detection algorithms, the original CPU interface continues to be used because the output data is in a vector format rather than an image format.

In this embodiment, the first processor and the second processor are invoked by a created thread to execute the corresponding processing algorithms. A thread may be created such that the first processor is invoked by the created thread to execute the processing algorithm that is not re-edited, and the second processor is invoked by the created thread to execute the rewritten processing algorithm, according to the execution sequence of the algorithm directed graph. In order to improve the processing efficiency, it is also possible to create different threads and assign tasks to the different threads to invoke the first processor or the second processor to execute the corresponding processing algorithm.

As an example, the first processor may be invoked to execute the processing algorithm that is not re-edited, and the second processor may be invoked to execute the rewritten processing algorithm, according to the execution sequence of the algorithm directed graph by: dividing the processing algorithms in the algorithm directed graph into two groups, to obtain a front algorithm group and a back algorithm group; creating a first thread for the front algorithm group, and invoking the first processor and/or the second processor by the first thread to execute a processing algorithm in the front algorithm group; and creating a second thread for the back algorithm group, and invoking the first processor and/or the second processor by the second thread to execute a processing algorithm in the back algorithm group.

The dividing the processing algorithms in the algorithm directed graph into two groups can be understood as dividing the processing algorithms arranged at the front of the algorithm directed graph into one group, and dividing the processing algorithms arranged at the back of the algorithm directed graph into one group.

The processing algorithms in the algorithm directed graph may be divided into the two groups by: obtaining a first number of consecutive rewritten processing algorithms that are arranged at the back of the algorithm directed graph; and if the first number is less than or equal to half a total number of nodes in the algorithm directed graph, putting the first number of rewritten processing algorithms into one group as the back algorithm group, and putting the remaining processing algorithms into one group as the front algorithm group; or if the first number is greater than half the total number of nodes in the algorithm directed graph, putting rewritten processing algorithms of half the total number of nodes into one group as the back algorithm group, and putting the remaining processing algorithms into one group as the front algorithm group.

In this embodiment, after the processing algorithms that meet the set condition are re-edited, most or all of the processing algorithms in the algorithm directed graph may be re-edited, and the processing algorithms arranged at the front of the algorithm directed graph (i.e., the processing algorithms in the pre-processing stage) may not meet the set condition, that is, have not been re-edited. Therefore, the processing algorithms that are arranged at the back of and are successively rewritten may be obtained from the algorithm directed graph.

If the first number is less than or equal to half the total number of nodes in the algorithm directed graph, the first number of rewritten processing algorithms is directly used as the back algorithm group, and the remaining processing algorithms are put into the front algorithm group. Such a front algorithm group includes the processing algorithms that are not re-edited and/or the rewritten processing algorithms, and the back algorithm group includes only the rewritten processing algorithms. The first thread is created for the front algorithm group, and the first processor and/or the second processor is invoked by the first thread to execute a processing algorithm in the front algorithm group. The second thread is created for the back algorithm group, and the second processor is invoked by the second thread to execute a processing algorithm in the front algorithm group. By dividing the consecutive rewritten processing algorithms into one group, the second thread can be prevented from invoking the second processor all the time, without the need for switching to invoke the other processor.

If the first number is greater than half the total number of nodes in the algorithm directed graph, the rewritten processing algorithms of half the total number of nodes are put into one group as the back algorithm group, and the remaining processing algorithms are put into one group as the front algorithm group. Such a front algorithm group includes the processing algorithms that are not re-edited and/or the rewritten processing algorithms, and the back algorithm group includes only the rewritten processing algorithms, with similar numbers of nodes in the two groups. The first thread is created for the front algorithm group, and the first processor and/or the second processor is invoked by the first thread to execute a processing algorithm in the front algorithm group. The second thread is created for the back algorithm group, and the second processor is invoked by the second thread to execute a processing algorithm in the front algorithm group. In this embodiment, similar numbers of nodes in the two groups can ensure balanced allocation of resources.

As an example, the process of invoking the first processor and/or the second processor by the first thread to execute a processing algorithm in the front algorithm group may include: invoking, by the first thread, the first processor to execute the processing algorithm that is not re-edited, and the second processor to execute the rewritten processing algorithm, according to an execution sequence of the front algorithm group; and The process of invoking the first processor and/or the second processor by the second thread to execute a processing algorithm in the back algorithm group may include: invoking, by the second thread, the first processor to execute the processing algorithm that is not re-edited, and the second processor to execute the rewritten processing algorithm, according to the execution sequence of the back algorithm group.

In this embodiment, when the processing algorithm in the front algorithm group is executed, the first thread is activated, and according to the execution sequence of the front algorithm group, if a processing algorithm that is not re-edited is executed, the first processor is invoked for execution; or if a rewritten processing algorithm is executed, the second processor is invoked for execution. In this application scenario, since the back algorithm group includes only rewritten processing algorithms, the second thread is activated when processing algorithm in the back algorithm group are executed, and the second processor is invoked for execution in sequence according to the execution sequence of the front algorithm group. In this embodiment, the processing algorithms are executed in sequence according to the sequence of the algorithm directed graph, which can ensure that the target task is completed smoothly and accurately.

Optionally, the first processor may be invoked to execute the processing algorithm that is not re-edited, and the second processor may be invoked to execute the rewritten processing algorithm, according to the execution sequence of the algorithm directed graph by: creating a third thread for the processing algorithm that is not re-edited, and creating a fourth thread for the rewritten processing algorithm; and invoking the first processor by the third thread to execute the processing algorithm that is not re-edited, and invoking the second processor by the fourth thread to execute the rewritten processing algorithm, according to the execution sequence of the algorithm directed graph.

In this embodiment, the processing algorithms that are not re-edited are put into one group, and the rewritten processing algorithms are put into the other group. A thread, i.e., the third thread, is created for the processing algorithm that is not re-edited, and a thread, i.e., the fourth thread, is created for the rewritten processing algorithm. As an example, according the execution sequence of the algorithm directed graph, when the processing algorithm that is not re-edited is executed, the third thread is activated (the fourth thread is now inactivated) to invoke the first processor to execute the processing algorithm; and when the rewritten processing algorithm is executed, the fourth thread is activated (the third thread is now inactivated) to invoke the second processor to execute the processing algorithm. In this embodiment, a thread is created for the same type of processing algorithm, so that the thread invokes the same processor throughout the execution of the task, which can avoid the switching frequency when the thread invokes the processor.

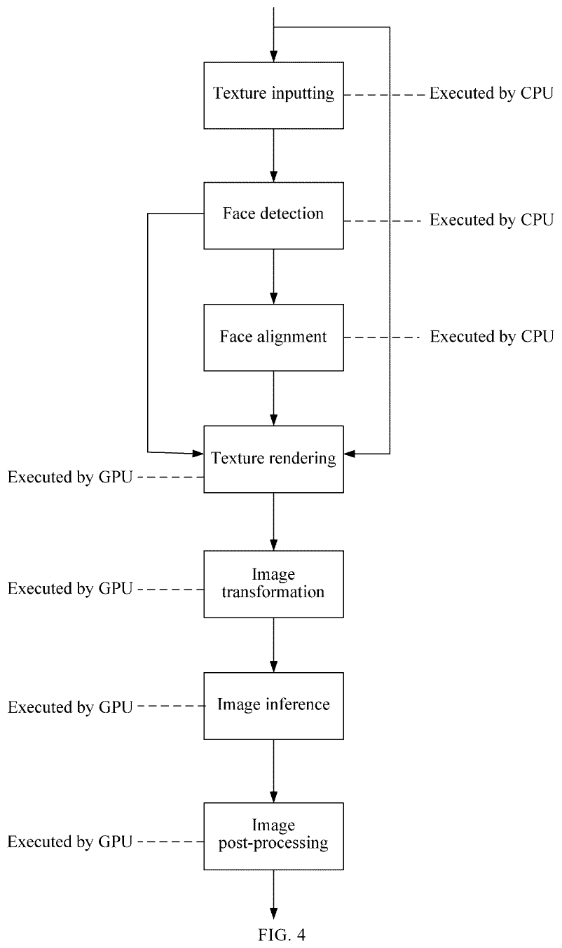

As an example, taking “bubble effect rendering” as an example, the required processing algorithms include in sequence: texture inputting (texture blit), face detection (face detect), face alignment (face align), texture rendering (render), image transformation (nh-image transform), image inference (nh-inference), and image post-processing (nh-post process). FIG. 4 is a diagram of an example of a processing process of an instance of a target task. As shown in FIG. 4, in the algorithm directed graph, the first three processing algorithms of texture blit, face detect, and face align are executed by invoking the CPU, and the last four processing algorithms of render, nh-image transform, nh-inference, and nh-post process are executed by invoking the GPU. As can be seen from FIG. 4, only one switching between the CPU and the GPU is performed in the link of the directed graph, thereby effectively reducing the data exchange between the CPU and the GPU, and greatly increasing the data processing efficiency.

The technical solution of the embodiment of the present disclosure lie in: obtaining an algorithm directed graph corresponding to a target task, where the algorithm directed graph includes a plurality of algorithm nodes, and one algorithm node corresponds to one processing algorithm; re-editing a processing algorithm that meets a set condition, to obtain a rewritten processing algorithm; and invoking a first processor to execute a processing algorithm that is not re-edited, and invoking a second processor to execute the rewritten processing algorithm, according to an execution sequence of the algorithm directed graph. By means of the data processing method provided by the embodiment of the present disclosure, the processing algorithm that meets the set condition is re-edited, such that the rewritten processing algorithm can be executed by the second processor. The number of switchings between the first processor and the second processor can be reduced when executing the processing algorithms in the algorithm directed graph, thereby saving computing and memory resources and improving the data processing efficiency.

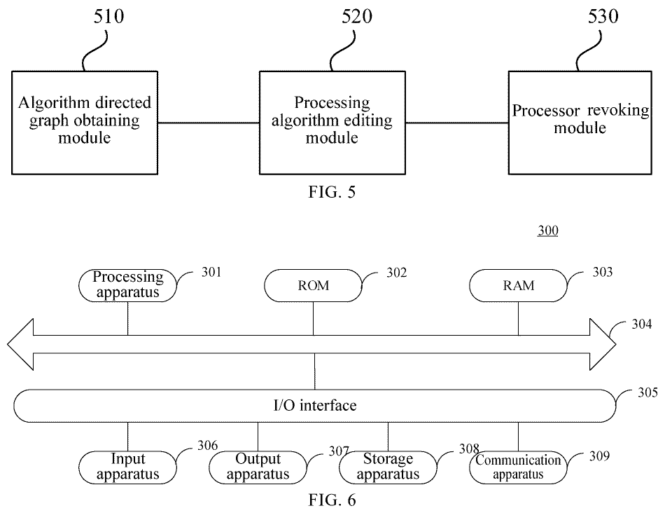

FIG. 5 is a schematic diagram of a structure of a data processing apparatus according to an embodiment of the present disclosure. As shown in FIG. 5, the apparatus includes: an algorithm directed graph obtaining module 510 configured to obtain an algorithm directed graph corresponding to a target task, where the algorithm directed graph includes a plurality of algorithm nodes, and one algorithm node corresponds to one processing algorithm; a processing algorithm editing module 520 configured to re-edit a processing algorithm that meets a set condition, to obtain a rewritten processing algorithm; and a processor invoking module 530 configured to invoke a first processor to execute a processing algorithm that is not re-edited, and invoke a second processor to execute the rewritten processing algorithm, according to an execution sequence of the algorithm directed graph.

Optionally, the set condition is that the processing algorithm belongs to a set category, and the processing algorithm editing module 520 is configured to reedit the processing algorithm that meets the set condition, to obtain the rewritten processing algorithm by:
re-editing the processing algorithm that meets the set condition according to a format supported by the second processor, and rewriting an input interface and an output interface of the processing algorithm into interfaces supported by the second processor, to obtain the rewritten processing algorithm.

Optionally, the set category includes any one of the following: landmark detection, image segmentation, and image transformation.

Optionally, the processor invoking module 530 is configured to invoke the processors to execute the processing algorithms by:
dividing the processing algorithms in the algorithm directed graph into two groups, to obtain a front algorithm group and a back algorithm group;
creating a first thread for the front algorithm group, and invoking the first processor and/or the second processor by the first thread to execute a processing algorithm in the front algorithm group; and
creating a second thread for the back algorithm group, and invoking the first processor and/or the second processor by the second thread to execute a processing algorithm in the back algorithm group.

Optionally, the processor invoking module 530 is configured to obtain the front and back algorithm groups by:
obtaining a first number of consecutive rewritten processing algorithms that are arranged at the back of the algorithm directed graph; and
if the first number is less than or equal to half a total number of nodes in the algorithm directed graph, putting the first number of rewritten processing algorithms into one group as the back algorithm group, and putting the remaining processing algorithms into one group as the front algorithm group; or
if the first number is greater than half the total number of nodes in the algorithm directed graph, putting the rewritten processing algorithms of half the total number of nodes into one group as the back algorithm group, and putting the remaining processing algorithms into one group as the front algorithm group.

Optionally, the processor invoking module 530 is configured to invoke the processors to execute the processing algorithms according to the execution sequence of the front algorithm group by:
invoking, by the first thread, the first processor to execute the processing algorithm that is not re-edited, and the second processor to execute the rewritten processing algorithm, according to an execution sequence of the front algorithm group.

Optionally, the processor invoking module 530 is configured to invoke the processors to execute the processing algorithms according to the execution sequence of the back algorithm group by:
invoking, by the second thread, the first processor to execute the processing algorithm that is not re-edited, and the second processor to execute the rewritten processing algorithm, according to the execution sequence of the back algorithm group.

Optionally, the processor invoking module 530 is configured to create threads and to invoke the processors to execute the processing algorithms by:
creating a third thread for the processing algorithm that is not re-edited, and creating a fourth thread for the rewritten processing algorithm; and
invoking the first processor by the third thread to execute the processing algorithm that is not re-edited, and invoking the second processor by the fourth thread to execute the rewritten processing algorithm, according to the execution sequence of the algorithm directed graph.

The apparatus described above can perform the method provided in all the foregoing embodiments of the present disclosure, and has corresponding functional modules and beneficial effects for performing the method described above. For the technical details not described in detail in this embodiment, reference may be made to the method provided in all the above embodiments of the present disclosure.

Reference is made to FIG. 6 below, which is a schematic diagram of a structure of an electronic device 300 suitable for implementing an embodiment of the present disclosure. The electronic device in the embodiment of the present disclosure may include a mobile terminal such as a mobile phone, a notebook computer, a digital broadcast receiver, a personal digital assistant (PDA), a tablet computer (Portable Android Device, PAD), a portable media player (PMP), and a vehicle-mounted terminal (such as a vehicle navigation terminal), and a fixed terminal such as a digital television (TV) and a desktop computer, or various forms of servers such as a separate server or a server cluster. The electronic device shown in FIG. 6 is merely an example.

As shown in FIG. 6, the electronic device 300 may include a processing apparatus (e.g., a central processing unit, a graphics processing unit, etc.) 301. The processing apparatus 301 may perform a variety of appropriate actions and processing in accordance with a program stored in a read only memory (ROM) 302 or a program loaded from a storage apparatus 308 into a random access memory (RAM) 303. Various programs and data required for the operation of the electronic device 300 are further stored in the RAM 303. The processing apparatus 301, the ROM 302, and the RAM 303 are connected to one another via a bus 304. An input/output (I/O) interface 305 is also connected to the bus 304.

Generally, the following apparatuses may be connected to the I/O interface 305: an input apparatus 306 including, for example, a touchscreen, a touchpad, a keyboard, a mouse, a camera, a microphone, an accelerometer, and a gyroscope; an output apparatus 307 including, for example, a liquid crystal display (LCD), a speaker, and a vibrator; the storage apparatus 308 including, for example, a tape and a hard disk; and a communication apparatus 309. The communication apparatus 309 may allow the electronic device 300 to perform wireless or wired communication with other devices to exchange data. Although FIG. 6 shows the electronic device 300 having various apparatuses, it should be understood that it is not required to implement or have all of the shown apparatuses. It may be an alternative to implement or have more or fewer apparatuses.

In an embodiment, the processes described above with reference to the flowcharts may be implemented as a computer software program according to this embodiment of the present disclosure. For example, an embodiment of the present disclosure includes a computer program product, which includes a computer program carried on a computer-readable medium, where the computer program includes program codes for performing the data processing method. In such an embodiment, the computer program may be downloaded from a network through the communication apparatus 309 and installed, installed from the storage apparatus 308, or installed from the ROM 302. When the computer program is executed by the processing apparatus 301, the above-mentioned functions defined in the method of the embodiment of the present disclosure are performed.

It should be noted that the above computer-readable medium described in the present disclosure may be a computer-readable signal medium, a computer-readable storage medium, or a combination thereof. The computer-readable storage medium may be, for example, electric, magnetic, optical, electromagnetic, infrared, or semiconductor systems, apparatuses, or devices, or a combination thereof. Examples of the computer-readable storage medium may include: an electrical connection having one or more wires, a portable computer disk, a hard disk, a random access memory (RAM), a read only memory (ROM), an erasable programmable read only memory (such as an electronic programmable read only memory (EPROM) or flash memory), an optical fiber, a portable compact disc-read only memory (CD-ROM), an optical storage device, a magnetic storage device, or a suitable combination thereof. In the present disclosure, the computer-readable storage medium may be a tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including an electromagnetic signal, an optical signal, or a suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including: electric wires, optical cables, radio frequency (RF), etc., or a suitable combination thereof.

In some implementations, a client and a server can communicate using any currently known or future-developed network protocol such as a HyperText Transfer Protocol (HTTP), and may be connected to digital data communication (for example, communication network) in any form or medium. Examples of the communication network include a local area network (LAN), a wide area network (WAN), an internetwork (e.g., the Internet), a peer-to-peer network (e.g., an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries at least one program, and the at least one program, when executed by the electronic device, causes the electronic device to: obtain an algorithm directed graph corresponding to a target task, where the algorithm directed graph includes a plurality of algorithm nodes, and one algorithm node corresponds to one processing algorithm; re-edit a processing algorithm that meets a set condition, to obtain a rewritten processing algorithm; and invoke a first processor to execute a processing algorithm that is not re-edited, and invoke a second processor to execute the rewritten processing algorithm, according to an execution sequence of the algorithm directed graph.

Computer program code for performing operations of the present disclosure can be written in one or more programming languages or a combination thereof, where the programming languages include object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by at least one hardware logic component. For example, exemplary types of hardware logic components that may be used include: a field-programmable gate array (FPGA), an application-specific integrated circuit (ASIC), application-specific standard parts (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatuses, or devices, or a suitable combination thereof. Examples of the machine-readable storage medium may include an electrical connection based on one or more wires, a portable computer disk, a hard disk, a random access memory (RAM), a read only memory (ROM), an erasable programmable read only memory (EPROM or flash memory), an optic fiber, a portable compact disc-read only memory (CD-ROM), an optical storage device, a magnetic storage device, or any suitable combination thereof.

According to one or more of the embodiments of the present disclosure, an embodiment of the present disclosure discloses a data processing method, including:
obtaining an algorithm directed graph corresponding to a target task, where the algorithm directed graph includes a plurality of algorithm nodes, and one algorithm node corresponds to one processing algorithm;
re-editing a processing algorithm that meets a set condition, to obtain a rewritten processing algorithm; and
invoking a first processor to execute a processing algorithm that is not re-edited, and invoking a second processor to execute the rewritten processing algorithm, according to an execution sequence of the algorithm directed graph.

Further, the set condition is that the processing algorithm belongs to a set category, and the re-editing a processing algorithm that meets a set condition, to obtain a rewritten processing algorithm includes:
re-editing the processing algorithm that meets the set condition according to a format supported by the second processor, and rewriting an input interface and an output interface of the processing algorithm into interfaces supported by the second processor, to obtain the rewritten processing algorithm.

Further, the set category includes any one of the following: landmark detection, image segmentation, and image transformation.

Further, the invoking a first processor to execute a processing algorithm that is not re-edited, and invoking a second processor to execute the rewritten processing algorithm, according to an execution sequence of the algorithm directed graph includes:
dividing the processing algorithms in the algorithm directed graph into two groups, to obtain a front algorithm group and a back algorithm group;
creating a first thread for the front algorithm group, and invoking the first processor and/or the second processor by the first thread to execute a processing algorithm in the front algorithm group; and
creating a second thread for the back algorithm group, and invoking the first processor and/or the second processor by the second thread to execute a processing algorithm in the back algorithm group.

Further, the dividing the processing algorithms in the algorithm directed graph into two groups includes:
obtaining a first number of consecutive rewritten processing algorithms that are arranged at the back of the algorithm directed graph; and
if the first number is less than or equal to half a total number of nodes in the algorithm directed graph, putting the first number of rewritten processing algorithms into one group as the back algorithm group, and putting the remaining processing algorithms into one group as the front algorithm group; or
if the first number is greater than half the total number of nodes in the algorithm directed graph, putting the rewritten processing algorithms of half the total number of nodes into one group as the back algorithm group, and putting the remaining processing algorithms into one group as the front algorithm group.

Further, the invoking the first processor and/or the second processor by the first thread to execute a processing algorithm in the front algorithm group includes:
invoking, by the first thread, the first processor to execute the processing algorithm that is not re-edited, and the second processor to execute the rewritten processing algorithm, according to an execution sequence of the front algorithm group; and
the invoking the first processor and/or the second processor by the second thread to execute a processing algorithm in the back algorithm group includes:
invoking, by the second thread, the first processor to execute the processing algorithm that is not re-edited, and the second processor to execute the rewritten processing algorithm, according to the execution sequence of the back algorithm group.

Further, the invoking a first processor to execute a processing algorithm that is not re-edited, and invoking a second processor to execute the rewritten processing algorithm, according to an execution sequence of the algorithm directed graph includes:
creating a third thread for the processing algorithm that is not re-edited, and creating a fourth thread for the rewritten processing algorithm; and
invoking the first processor by the third thread to execute the processing algorithm that is not re-edited, and invoking the second processor by the fourth thread to execute the rewritten processing algorithm, according to the execution sequence of the algorithm directed graph.

It should be understood that the steps may be re-ordered, added or deleted using the various forms of process shown above. For example, the steps described in the present disclosure may be performed in parallel, in sequence or in a different order, as long as the desired results of the technical solution of the present disclosure are achieved.

1. A data processing method, comprising:
obtaining an algorithm directed graph corresponding to a target task, wherein the algorithm directed graph comprises a plurality of algorithm nodes, and one algorithm node corresponds to one processing algorithm;
re-editing a processing algorithm that meets a set condition, to obtain a rewritten processing algorithm; and
invoking a first processor to execute a processing algorithm that is not re-edited, and invoking a second processor to execute the rewritten processing algorithm, according to an execution sequence of the algorithm directed graph.

2. The method according to claim 1, wherein the set condition is that the processing algorithm belongs to a set category, and the re-editing a processing algorithm that meets a set condition, to obtain a rewritten processing algorithm comprises:
re-editing the processing algorithm that meets the set condition according to a format supported by the second processor, and rewriting an input interface and an output interface of the processing algorithm into interfaces supported by the second processor, to obtain the rewritten processing algorithm.

3. The method according to claim 2, wherein the set category comprises any one of the following: landmark detection, image segmentation, and image transformation.

4. The method according to claim 1, wherein the invoking a first processor to execute a processing algorithm that is not re-edited, and invoking a second processor to execute the rewritten processing algorithm, according to an execution sequence of the algorithm directed graph comprises:
dividing the processing algorithms in the algorithm directed graph into two groups, to obtain a front algorithm group and a back algorithm group;
creating a first thread for the front algorithm group, and invoking at least one of the first processor and the second processor by the first thread to execute a processing algorithm in the front algorithm group; and
creating a second thread for the back algorithm group, and invoking at least one of the first processor and the second processor by the second thread to execute a processing algorithm in the back algorithm group.

5. The method according to claim 4, wherein the dividing the processing algorithms in the algorithm directed graph into two groups comprises:
obtaining a first number of consecutive rewritten processing algorithms that are arranged at the back of the algorithm directed graph; and
in response to the first number being less than or equal to half a total number of nodes in the algorithm directed graph, putting the first number of rewritten processing algorithms into one group as the back algorithm group, and putting the remaining processing algorithms into one group as the front algorithm group; or
in response to the first number being greater than half the total number of nodes in the algorithm directed graph, putting rewritten processing algorithms of half the total number of nodes into one group as the back algorithm group, and putting the remaining processing algorithms into one group as the front algorithm group.

6. The method according to claim 4, wherein the invoking at least one of the first processor and the second processor by the first thread to execute a processing algorithm in the front algorithm group comprises:
invoking, by the first thread, the first processor to execute the processing algorithm that is not re-edited, and the second processor to execute the rewritten processing algorithm, according to an execution sequence of the front algorithm group; and
the invoking at least one of the first processor and the second processor by the second thread to execute a processing algorithm in the back algorithm group comprises:
invoking, by the second thread, the first processor to execute the processing algorithm that is not re-edited, and the second processor to execute the rewritten processing algorithm, according to the execution sequence of the back algorithm group.

7. The method according to claim 1, wherein the invoking a first processor to execute a processing algorithm that is not re-edited, and invoking a second processor to execute the rewritten processing algorithm, according to an execution sequence of the algorithm directed graph comprises:
creating a third thread for the processing algorithm that is not re-edited, and creating a fourth thread for the rewritten processing algorithm; and
invoking the first processor by the third thread to execute the processing algorithm that is not re-edited, and invoking the second processor by the fourth thread to execute the rewritten processing algorithm, according to the execution sequence of the algorithm directed graph.

8. (canceled)

9. An electronic device, comprising:
one or more processing apparatuses; and
a storage apparatus configured to store one or more programs, wherein
the one or more programs, when executed by the one or more processing apparatuses, cause the one or more processing apparatuses to:
obtain an algorithm directed graph corresponding to a target task, wherein the algorithm directed graph comprises a plurality of algorithm nodes, and one algorithm node corresponds to one processing algorithm;
re-edit a processing algorithm that meets a set condition, to obtain a rewritten processing algorithm; and
invoke a first processor to execute a processing algorithm that is not re-edited, and invoking a second processor to execute the rewritten processing algorithm, according to an execution sequence of the algorithm directed graph.

10. A non-transitory computer-readable medium having a computer program stored thereon, wherein the computer program, when executed by a processing apparatus, causes the processing apparatus to:
obtain an algorithm directed graph corresponding to a target task, wherein the algorithm directed graph comprises a plurality of algorithm nodes, and one algorithm node corresponds to one processing algorithm;
re-edit a processing algorithm that meets a set condition, to obtain a rewritten processing algorithm; and
invoke a first processor to execute a processing algorithm that is not re-edited, and invoking a second processor to execute the rewritten processing algorithm, according to an execution sequence of the algorithm directed graph.

11. The electronic device according to claim 9, wherein the set condition is that the processing algorithm belongs to a set category, and the re-editing a processing algorithm that meets a set condition, to obtain a rewritten processing algorithm comprises:
re-editing the processing algorithm that meets the set condition according to a format supported by the second processor, and rewriting an input interface and an output interface of the processing algorithm into interfaces supported by the second processor, to obtain the rewritten processing algorithm.

12. The electronic device according to claim 11, wherein the set category comprises any one of the following: landmark detection, image segmentation, and image transformation.

13. The electronic device according to claim 9, wherein the invoking a first processor to execute a processing algorithm that is not re-edited, and invoking a second processor to execute the rewritten processing algorithm, according to an execution sequence of the algorithm directed graph comprises:
dividing the processing algorithms in the algorithm directed graph into two groups, to obtain a front algorithm group and a back algorithm group;
creating a first thread for the front algorithm group, and invoking at least one of the first processor and the second processor by the first thread to execute a processing algorithm in the front algorithm group; and
creating a second thread for the back algorithm group, and invoking at least one of the first processor and the second processor by the second thread to execute a processing algorithm in the back algorithm group.

14. The electronic device according to claim 13, wherein the dividing the processing algorithms in the algorithm directed graph into two groups comprises:
obtaining a first number of consecutive rewritten processing algorithms that are arranged at the back of the algorithm directed graph; and
in response to the first number being less than or equal to half a total number of nodes in the algorithm directed graph, putting the first number of rewritten processing algorithms into one group as the back algorithm group, and putting the remaining processing algorithms into one group as the front algorithm group; or
in response to the first number being greater than half the total number of nodes in the algorithm directed graph, putting rewritten processing algorithms of half the total number of nodes into one group as the back algorithm group, and putting the remaining processing algorithms into one group as the front algorithm group.

15. The electronic device according to claim 13, wherein the invoking at least one of the first processor and the second processor by the first thread to execute a processing algorithm in the front algorithm group comprises:
invoking, by the first thread, the first processor to execute the processing algorithm that is not re-edited, and the second processor to execute the rewritten processing algorithm, according to an execution sequence of the front algorithm group; and
the invoking at least one of the first processor and the second processor by the second thread to execute a processing algorithm in the back algorithm group comprises:
invoking, by the second thread, the first processor to execute the processing algorithm that is not re-edited, and the second processor to execute the rewritten processing algorithm, according to the execution sequence of the back algorithm group.

16. The electronic device according to claim 9, wherein the invoking a first processor to execute a processing algorithm that is not re-edited, and invoking a second processor to execute the rewritten processing algorithm, according to an execution sequence of the algorithm directed graph comprises:
creating a third thread for the processing algorithm that is not re-edited, and creating a fourth thread for the rewritten processing algorithm; and
invoking the first processor by the third thread to execute the processing algorithm that is not re-edited, and invoking the second processor by the fourth thread to execute the rewritten processing algorithm, according to the execution sequence of the algorithm directed graph.

17. The non-transitory computer-readable medium according to claim 10, wherein the set condition is that the processing algorithm belongs to a set category, and the re-editing a processing algorithm that meets a set condition, to obtain a rewritten processing algorithm comprises:
re-editing the processing algorithm that meets the set condition according to a format supported by the second processor, and rewriting an input interface and an output interface of the processing algorithm into interfaces supported by the second processor, to obtain the rewritten processing algorithm.

18. The non-transitory computer-readable medium according to claim 10, wherein the invoking a first processor to execute a processing algorithm that is not re-edited, and invoking a second processor to execute the rewritten processing algorithm, according to an execution sequence of the algorithm directed graph comprises:
dividing the processing algorithms in the algorithm directed graph into two groups, to obtain a front algorithm group and a back algorithm group;
creating a first thread for the front algorithm group, and invoking at least one of the first processor and the second processor by the first thread to execute a processing algorithm in the front algorithm group; and
creating a second thread for the back algorithm group, and invoking at least one of the first processor and the second processor by the second thread to execute a processing algorithm in the back algorithm group.

19. The non-transitory computer-readable medium according to claim 18, wherein the dividing the processing algorithms in the algorithm directed graph into two groups comprises:
obtaining a first number of consecutive rewritten processing algorithms that are arranged at the back of the algorithm directed graph; and
in response to the first number being less than or equal to half a total number of nodes in the algorithm directed graph, putting the first number of rewritten processing algorithms into one group as the back algorithm group, and putting the remaining processing algorithms into one group as the front algorithm group; or
in response to the first number being greater than half the total number of nodes in the algorithm directed graph, putting rewritten processing algorithms of half the total number of nodes into one group as the back algorithm group, and putting the remaining processing algorithms into one group as the front algorithm group.

20. The non-transitory computer-readable medium according to claim 18, wherein the invoking at least one of the first processor and the second processor by the first thread to execute a processing algorithm in the front algorithm group comprises:
invoking, by the first thread, the first processor to execute the processing algorithm that is not re-edited, and the second processor to execute the rewritten processing algorithm, according to an execution sequence of the front algorithm group; and
the invoking at least one of the first processor and the second processor by the second thread to execute a processing algorithm in the back algorithm group comprises:
invoking, by the second thread, the first processor to execute the processing algorithm that is not re-edited, and the second processor to execute the rewritten processing algorithm, according to the execution sequence of the back algorithm group.

21. The non-transitory computer-readable medium according to claim 10, wherein the invoking a first processor to execute a processing algorithm that is not re-edited, and invoking a second processor to execute the rewritten processing algorithm, according to an execution sequence of the algorithm directed graph comprises:
creating a third thread for the processing algorithm that is not re-edited, and creating a fourth thread for the rewritten processing algorithm; and
invoking the first processor by the third thread to execute the processing algorithm that is not re-edited, and invoking the second processor by the fourth thread to execute the rewritten processing algorithm, according to the execution sequence of the algorithm directed graph.
